(19) United States
(12) Patent Application Publication
(10) Pub. No.: US 2003/0023005 A1
(43) Pub. Date: Jan. 30, 2003

(54) Method of preconditioning a resin for hydrogen peroxide purification, resin prepared therefrom and method of purifying hydrogen peroxide

(76) Inventors: Mary Dykstra Havlicek, Richardson, TX (US); Joe G. Hoffman, Dallas, TX (US); Wallace Yuan, Irvine, CA (US)

Correspondence Address: E. Joseph Gess, Esq., BURNS, DOANE, SWECKER & MATHIS, L.L.P., P.O. Box 1404, Alexandria, VA, 22313-1404, US

(21) Appl. No.: 09/824,765

(22) Filed: Apr. 4, 2001

(51) Int. Cl. C01B 15/013; C08F 8/30; C08F 8/34

(52) U.S. Cl. 525/344; 423/584; 525/374

(57) ABSTRACT

Provided is a method of preconditioning a resin useful for removal of organic impurities from a hydrogen peroxide solution. The method involves the steps of (a) rinsing the resin with deionized water; (b) contacting the resin with an acid solution; and (c) rinsing the acid treated resin with deionized water. Also provided is a resin preconditioned in accordance with the method, and a method of removing organic impurities from a hydrogen peroxide solution using the preconditioned resin. The invention has particular applicability to the removal of total organic carbon (TOC) impurities from a hydrogen peroxide solution which can be used in the manufacture of semiconductor devices.

### BACKGROUND OF THE INVENTION

1. Field of the Invention

This invention relates to a method of preconditioning a resin and to a resin prepared therefrom. The invention also relates to a method of removing organic impurities from a hydrogen peroxide solution using the preconditioned resin. The invention has particular applicability in the semiconductor manufacturing industry for the removal of total organic carbon (TOC) impurities from a hydrogen peroxide solution.

2. Description of the Related Art

Hydrogen peroxide (H₂O₂) is an important chemical in the semiconductor manufacturing industry. It is commonly used in solutions employed in wafer cleaning processes which are conducted in wet processing stations. For example, the well known piranha clean process employs a solution of hydrogen peroxide and sulfuric acid (H₂SO₄)in a ratio of 3:7. Other processes employing hydrogen peroxide solutions include, for example, the RCA SC-1 clean which involves a solution of ammonium hydroxide (NH₄OH) and hydrogen peroxide in a ratio of 5:1:1, and the RCA SC-2 clean, which uses a solution of hydrochloric acid (HC1) and hydrogen peroxide in a ratio of 6:1:1.

To reduce the probability of device failure, it is important in semiconductor device fabrication that the materials which contact the wafers being treated be of very high purity. The extreme purity levels required in semiconductor manufacturing are rare and unique among industrial processes. While existing techniques of purifying hydrogen peroxide may significantly reduce the amount of contaminants, solutions of even greater purity are desirable.

Commercial grade hydrogen peroxide is generally produced by the so-called anthraquinone method. This method involves auto-oxidation of anthraquinone, which results in the presence of large amounts of organic contaminants in solution. The contaminants may either originate from the anthraquinone or from the organic solvents used in preparing the hydrogen peroxide solution from the anthraquinone. Typical organic contaminants in hydrogen peroxide solutions include, for example, alcohols, aldehydes and other organic substances which cannot be effectively removed by ion exchange resins.

It is conventional practice to treat hydrogen peroxide prior to shipping to remove organic impurities. For example, it is known to remove organic contaminants by extraction with a water miscible organic solvent. However, the purified solution still contains organic impurities in amounts that are not acceptable for use in the semiconductor industry.

One method for significantly decreasing the amount of organic impurities in a hydrogen peroxide solution involves contacting the solution with a resin which can adsorb the organic contaminants and separate them from the solution. Hydrogen peroxide solutions purified in this manner can achieve high purity levels with respect to TOC's.

There are, however, various problems associated with the use of adsorbent resins to remove organic impurities from an aqueous hydrogen peroxide solution. For example, resins used to treat hydrogen peroxide for removal of impurities may contain metals and bases due to manufacturing and/or storage procedures. When the hydrogen peroxide solution is brought into contact with the resin, the solution is prone to decomposition. Such decomposition is further accelerated due to the basic nature of and presence of metals in the resin, which catalyze the hydrogen decomposition.

Decomposition of the hydrogen peroxide solution can be particularly problematic as a result of the exothermic nature of the reaction. The temperature near the zone of contact between the resin and the solution can increase very rapidly, increasing the rate of decomposition. This can result in a self-accelerating reaction, possibly terminating in an explosion of the purification equipment.

Thus, there remains a need for a resin-based method and system for removing organic impurities from a hydrogen peroxide solution in a safe and cost effective manner.

Copending Application Ser. No.______, Attorney Docket No. 016499-650, the contents of which are hereby incorporated by reference in their entirety, provides novel methods of preconditioning a resin useful for removal of organic impurities from a hydrogen peroxide solution. The method employs a hydrogen peroxide solution in preconditioning the resin. This method is particularly desirable when equipment simplicity and downtime minimization are required. It is noted, however, that employing a hydrogen peroxide solution in preconditioning the resin increases the cost of operating a hydrogen purification unit based thereon.

To meet the requirements of the semiconductor manufacturing industry and to overcome the disadvantages of the related art, it is an object of the present invention to provide novel methods of preconditioning a resin useful for removal of organic impurities from a hydrogen peroxide solution. The invention has particular applicability in the semiconductor manufacturing industry in the removal of total organic carbons (TOC's) from hydrogen peroxide solutions.

It is a further object of the invention to provide a resins prepared by the novel preconditioning methods.

It is yet a further object of the invention to provide methods of removing organic impurities from a hydrogen peroxide solution using resins prepared by the novel preconditioning methods.

Other objects and aspects of the present invention will become apparent to one of ordinary skill in the art on a review of the specification, drawings and claims appended hereto.

### BRIEF DESCRIPTION OF THE DRAWINGS

The objects and advantages of the invention will become apparent from the following detailed description of the preferred embodiments thereof in connection with the accompanying drawings, in which:

FIG. 1 is a schematic diagram of the experimental set up for determining hydrogen peroxide decomposition take off temperature.

FIG. 2 is a detailed diagram of the unit for chemical analysis of the gases leaving the reactor of FIG. 1.

FIG. 3 is a graph illustrating the temperature profile inside a hydrogen peroxide purification reactor using a resin which has not been preconditioned in accordance with the invention; and

FIG. 4 is a graph illustrating the temperature profile inside a hydrogen peroxide purification reactor using a resin which has been preconditioned in accordance with the invention.

### SUMMARY OF THE INVENTION

In accordance with the present invention, a method of preconditioning a resin useful for removal of organic impurities from a hydrogen peroxide solution is provided. The method comprises the steps of:

(a) rinsing the resin with deionized water;

(b) contacting the resin with an acid solution; and

(c) rinsing the acid-treated resin with deionized water.

The acid solution is preferably an aqueous solution of a strong acid. Suitable strong acid solutions include, for example, solutions of hydrochloric acid (HCl), nitric acid (HNO₃) or sulfuric acid (H₂SO₄).

By preconditioning a resin in accordance with the invention, the content of metal impurities in the resin can be effectively reduced in a safe and facile manner. The method of the invention is particularly effective for reducing the content of transition metals, such as iron and copper, and other metal impurities such as boron (B), calcium (Ca), magnesium (Mg), zinc (Zn), potassium (K), silicon (Si), sodium (Na), or mixtures thereof. Hydrogen peroxide decomposition and the possibility of explosion of the purification equipment during TOC removal can, in turn, be significantly reduced.

In accordance with a further aspect of the invention, a resin preconditioned for removal of impurities from a hydrogen peroxide solution is provided. The resin is preconditioned by the above preconditioning method.

In accordance with a further aspect of the invention, a method of removing organic impurities from a hydrogen peroxide solution is provided. The method comprises passing the hydrogen peroxide solution through a column containing a resin bed preconditioned by the above preconditioning method.

### DETAILED DESCRIPTION OF THE PREFERRED EMBODIMENTS OF THE INVENTION

The invention will now be described with reference to exemplary embodiments thereof. A first aspect of the invention involves a method of preconditioning a resin which can be employed in the removal of organic impurities from a hydrogen peroxide solution.

The invention can be applied to any resin suitable for removing organic impurities from hydrogen peroxide solutions. Resins capable of adsorbing organic impurities which cannot be removed by ion-exchange resins are particularly suited for the preconditioning method according to the invention. Preconditioned hydrophobic resins have been found to work particularly well in removing organic impurities from hydrogen peroxide solutions. Application to hydrophylic resins is also expected to provide beneficial results. Of various commercially available resins, AMBERLITE XAD-4 and AMBERSORB 563, available from Rohm and Haas, have been found to work particularly well with the present invention.

The preconditioning method can be practiced in a batch mode, a continuous flow mode, or a combination of batch and continuous flow modes. In one example of batch mode preconditioning, the resin is first placed in a clean container. The container can be, for example, a simple vessel with an opening for introducing and removing the resin and liquid treatment agents to and from the container. Preferably, conduits are connected to the container for introducing fresh liquid treatment agents and for draining the spent agents.

The material of construction of the container should be compatible with the resin and other materials which contact the container to avoid resin contamination. Preferred materials include, for example, polyethylene, polypropylene, polyvinylidene fluoride (PVDF) and perfluoroalkoxy (PFA). The volume of the container will depend on the amount of resin desired to be preconditioned and thus on the resin bed volume employed in the hydrogen peroxide purification process. The process described herein can readily be scaled to any size by persons skilled in the art.

The container is preferably pre-cleaned by first rinsing with the same type of acid solution to be employed in the preconditioning, described below. Residual acid in the container can next be removed by rinsing with deionized water, followed by drying the container.

The container is partially filled with the resin to be treated, and deionized water is added to the container until the resin is covered with the deionized water. The container is preferably sealed to reduce the potential for contamination of the resin, and the resin is allowed to soak for a predetermined period of time. The deionized water is effective to remove various contaminants from the resin. The most effective period of time for soaking the resin in the deionized water varies according to the specific resin and types and amounts of contaminants present in the resin. For example, when the process is conducted for preconditioning AMBERSORB 563, it has been found that the soaking in deionized water is preferably conducted for at least 7 days. On the other hand, shorter resin soaking periods, from about 4 hours to 7 days, have been found to be effective with resins such as AMBERLITE XAD-4.

After soaking the resin in the deionized water, the water is drained from the container. To ensure removal from the resin of the contaminants which can be removed by the deionized water, the resin can be next rinsed with fresh deionized water. The rinsing can be performed by filling the container with fresh deionized water and by draining or otherwise separating the deionized water from the resin by techniques known to those skilled in the art, for example, decantation.

Contact time in the rinsing step after filling the container can be less than the above soaking step, for example, from about 0.5 to 5 hours. The rinsing step can be repeated any number of times, preferably until substantially all of the water-removable contaminants have been removed from the resin, and the pH of the drained water is about 7.

After the water soaking and rinsing steps, a portion of the contaminants initially present in the resin are removed. However, the residual contaminants remaining in the resin are difficult to remove by further treatment with deionized water alone. Such contaminants may include, for example, residual metal impurities, such as boron, calcium, iron, magnesium, zinc, potassium, silicon and sodium.

To remove or substantially reduce the amount of residual contaminants in the resin, the resin is next treated with an acid solution. Preferred acid solutions include dilute solutions of strong acids, for example, hydrochloric acid (HCl), nitric acid (HNO₃) and sulfuric acid (H₂SO₄).

In the case of a solution formed from a strong acid, a molar ratio of acid to water of from about 1:100 to 1:4 is typical, preferably from about 1:100 to 1:90. The container is charged with the acid solution until the resin is completely covered with the acid, and the container is preferably sealed. The resin is allowed to soak in the acid solution for a period of time effective to remove or substantially reduce the remaining contaminants in the resin.

The period of time for soaking the resin with the acid can be significantly shorter than that used in the deionized water soaking step, and will depend on factors such as the concentration of the acid solution. soaking the resin in acid for several hours, for example, from about 3 to about 8 hours, is typically sufficient to substantially reduce the amount of residual metal impurities in the resin. After soaking the resin with the acid solution, the acid is drained or otherwise removed from the container.

Following the acid soaking step, one or more acid rinse steps are preferably performed to remove residual contaminants remaining in the resin after the acid soaking step. The acid rinsing steps can be performed by filling the container with fresh acid solution and by draining or otherwise separating the acid from the resin by techniques known to those skilled in the art. The acid employed is preferably of the same type and the solution is typically of the same formulation as that used in the acid soaking step.

Contact time in the acid rinsing step after filling the container is typically less than the above acid soaking step and can be, for example, from about 0.25 to 7 hours. The acid rinsing step can be repeated any number of times until substantially all of the residual contaminants remaining after the acid soaking step have been removed from the resin.

After the acid treatment, the resin is washed with deionized water to remove from the resin any contaminants such as contaminants that may be deposited on the resin during treatment with the acid. For example, in the case of hydrochloric acid, the resin may become contaminated with chloride or other anion contaminants. Therefore, the resin is washed with an effective amount of deionized water until the anion content of the recovered washing deionized water is drastically reduced, for example, to less than 200 ppb.

Additional deionized water rinsing steps can be performed to ensure complete removal of the acid residue from the resin, and until the pH of the drained water is about 7. A number of water rinsing cycles, for example, between 2 and 10 is generally sufficient. The resin can be transferred at any time during or after the water rinsing to another clean container, where it can be rinsed again with deionized water. Typically, the effective rinsing requires contacting the resin with up to about 800 to 1000 bed volumes of deionized water.

The resin preconditioned in the above manner can be applied immediately to a hydrogen peroxide purification process or stored for later use. When the resin is not to be used immediately after preconditioning, it is preferred that the resin be stored in a contaminant free environment. For example, the resin can be placed in a clean container which is then filled with deionized water to cover the resin. The container is preferably sealed until the resin is to be used.

In accordance with a preferred aspect of the invention, resin preconditioning can be conducted in situ, in the same column used for the hydrogen peroxide TOC removal process. In such case, the resin to be preconditioned is introduced into the column, with the above-described acid treatment steps being conducted in the column. If desired, the water and/or acid during any of the steps can be made to continuously flow through the resin bed.

In accordance with a further aspect of the invention, a hydrogen peroxide solution can be purified by contacting the solution with a resin preconditioned as described above. In particular, resins preconditioned in accordance with the above-described process can beneficially be applied to a TOC removal process.

After all or substantially all the organic impurities in the solution have been adsorbed by the resin, the solution is recovered downstream from the purification column.

A column is first charged with a resin preconditioned in the manner described above to form a resin bed. A hydrogen peroxide solution to be purified is then passed through the resin bed column, thereby removing organic impurities from the solution.

The resin bed typically has a height from about 5 to 100 cm, and a diameter of from about 3 to 30 cm. The hydrogen peroxide throughput through the column is set such that all or substantially all of the organic impurities are removed from the solution as it passes through the column. The hydrogen peroxide solution to be purified is passed at a flow rate which depends on the type of resin, the resin bed volume, as well as other operating conditions, such as the pumping conditions and the pressure and temperature inside the purification reactor.

The hydrogen peroxide solution is preferably passed through the column in an upflow direction. Passing the hydrogen peroxide solution in an upflow direction provides various advantages. For example, upflow processing allows easy rise to the top and venting of gas bubbles formed by hydrogen peroxide decomposition in the column. Passing the hydrogen peroxide in an upflow direction is also advantageous in that formation of dry spots in the resin pack can be avoided, thus reducing the risk of overheating and/or microchanneling.

Controlling the flow rate of the solution can be performed using any conventional method. For example, the column can be connected to a metering pump which controls the flow rate of the solution through the resin.

The hydrogen peroxide can be passed through one or more additional TOC removal columns, if desired. In such a case, the columns can be disposed in series and/or parallel. After passage through the TOC removal column(s), the hydrogen peroxide solution can be stored in a reservoir for future use or can be passed through one or more ion exchange columns for further purification. For example, the solution treated for TOC removal can be sent to one or more anion and cation exchange columns.

Purifying a hydrogen peroxide solution with the preconditioned resin according to the invention is advantageous in that hydrogen peroxide decomposition can be eliminated or at the very least minimized. As a result, the temperature in the batch reactor or column and the hydrogen peroxide content in the solution can be maintained essentially constant during purification.

In order to further illustrate the present invention and the advantages thereof, the following specific examples are given, it being understood that same are intended only as illustrative and in no way limitative. Unless other wise indicated, all values are in ppb (parts-per-billion).

### EXAMPLES

The following examples illustrate the method of preconditioning a resin according to the invention.

### Example 1

The nature and amounts of contaminants present in commercial grade AMBERLITE XAD-4 resin were determined as follows. 20 ml of dry AMBERLITE XAD-4 resin were introduced into a 250 ml borosilicate glass beaker. Clean first and second containers were filled with deionized water obtained from the same source. The water in the first container was for treating the resin, while the water in the second container served as a reference for detection and measurement of the contaminants present in the resin. The beaker containing the resin was filled with deionized water from the first container until the resin was totally covered with the water. The resin was soaked in the deionized water for one day, and the water was separated from the resin by filtration.

The water separated from the resin (LEACH WATER) and the reference deionized water (DI WATER) were analyzed for the presence of metal impurities by inductively coupled plasma (ICP), ICP-Mass Spectroscopy and Atomic Absorption Spectroscopy analytical techniques The results of the analysis are reported in Table I.

### Example 2

Clean third and fourth containers were filled with a 1.7 N hydrochloric acid solution. The hydrochloric acid solution in the third container was used in treating the resin from Example 1, while the acid in the fourth container was used as a reference for measuring the contaminants leached from the resin upon treatment with the hydrochloric acid.

The resin was covered with the hydrochloric acid solution from the third container. The resin was maintained in the hydrochloric acid solution for three hours. A sample of the hydrochloric acid solution was then separated from the resin by decantation. The separated hydrochloric acid solution (LEACH HCl) and the reference acid solution (DIL. HCl) were analyzed in the same manner used for the deionized water samples in Example 1. The results of the analysis of the hydrochloric acid samples are also reported in Table I.

TABLE I

| | | LEACH | | |
|---|---|---|---|---|
| | DI WATER | WATER | DIL. HCl | LEACH HCl |
| pH | 7 | >10 | not tested | not tested |
| Boron | <3 | 211 | <9 | <9 |
| Calcium | <11 | 18,000 | 663 | 650 |
| Iron | <4 | 370 | 292 | 29 |
| Magnesium | <1 | 105 | 79 | 49 |
| Potassium | <93 | 603 | 68 | 2140 |
| Silicon | <22 | 111 | 118 | 60 |
| Sodium | 14,300 | 166,000 | 2220 | 530,000 |

The results reported in Table I show that commercial AMBERLITE XAD-4 contains a number of metal impurities which can adversely affect the hydrogen peroxide purification process. In particular, the results show that the resin contains metal impurities including iron, known to promote the autocatalytic decomposition reaction. The increase in the pH value between DI water and the leach water indicates that basic contaminants associated with the resin, such as sodium carbonate, are removed from the resin. Removal of such basic contaminants enhances the treatment with the acid, since acid neutralization by such basic components is reduced or totally avoided.

The results of Table I further demonstrate that large portions of the boron, calcium, iron, magnesium and silicon removed by the water and hydrochloric acid treatments can be removed by treating the resin with deionized water alone. However, the results also indicate that treatment with deionized water alone is not sufficient to remove all of the metal contaminants. For example, significant amounts of potassium and sodium remained in the resin after the treatment with deionized water alone. A significant amount of these impurities were removed by the hydrochloric acid treatment.

It is further noted that metals such as iron and magnesium can be complexed with hydrochloric acid during the acid treatment, and hence the reduced values obtained for those metals in the leach HCl compared to dilute HC1, as indicated in Table I.

### Example 3

The nature and amounts of metallic contaminants present in commercial grade AMBERSORB 563 resin were determined in the same manner described above with reference to Examples 1 and 2. The results obtained for AMBERSORB 563 are summarized in Table II as follows.

TABLE II

| | | LEACH | | |
|---|---|---|---|---|
| | DI WATER | WATER | DIL. HCl | LEACH HCl |
| pH | 6 | 6 | not tested | not tested |
| wt % HCl | — | — | 3.918 | 1.686 |
| Boron | <5 | 439 | <25 | 163 |
| Calcium | <8 | <8 | <40 | 6100 |
| Iron | <3 | 435 | <15 | 4800 |
| Magnesium | <2 | 4,936,000 | <10 | 2380 |
| Potassium | <5 | 6400 | <25 | 585 |
| Silicon | <16 | 1100 | <80 | 239 |
| Sodium | 11 | 8000 | 70 | 15,750 |
| Zinc | <3 | 122 | <15 | <15 |

These results confirm that commercial grade AMBERSORB 563 contains metal impurities including boron, calcium, iron, magnesium, potassium, silicon, sodium and zinc in various amounts.

The results of Table II further demonstrate that large portions of the boron, magnesium, potassium and silicon can be removed by treating the resin with deionized water alone. However, the results also show that treatment with deionized water alone is not sufficient to remove all of the metal contaminants. For example, significant amounts of calcium, iron and sodium remained in the resin after the treatment with deionized water. A significant amount of these impurities were, however, removed by the hydrochloric acid treatment.

The results discussed above indicate that commercial resins, such as AMBERLITE XAD-4 and AMBERSORB 563, contain metal contaminants known to have adverse effects on the hydrogen peroxide purification process even after water washing. In particular, these contaminants can lead to decomposition of the hydrogen peroxide with a possibly excessive reaction rate due to the heat produced by such decomposition. Also, by passing into the hydrogen peroxide solution, these contaminants may increase the amount of contaminants to be removed from the solution by an ion-exchange column downstream from the TOC removal column, thereby significantly reducing the hydrogen peroxide purification capacity of the ion-exchange column.

The following examples demonstrate the advantages that can be achieved by the hydrogen peroxide solution purification method in accordance with the invention.

### Example 4

The experiments for this example were conducted at Institut National de L'Environement Industriel et des Risques (INERIS), Parc Technologique Alata, Verneuil-en-Halatte, France.

This example illustrates the increased hydrogen peroxide stability that can be achieved upon contact with a resin preconditioned according to the invention. In particular, the example compares the take off temperature for hydrogen peroxide dissociation upon contact with a resin which is preconditioned according to the invention with a resin which is not so preconditioned. The take off temperature is the temperature at which a sharp acceleration in hydrogen peroxide decomposition occurs. The sharp increase in hydrogen peroxide decomposition was detected by a sharp increase in the temperature inside a reactor in which the hydrogen peroxide is contacted with the resin. The sharp acceleration in hydrogen peroxide decomposition was also detected by sampling and analyzing the composition of gases produced in the reactor. Hydrogen peroxide decomposition acceleration was also detected by allowing the pressure inside the reactor to build up until a controlled break down of a pressure safety seal occurred.

Two tests were conducted with the resin Ambersorb 563. Hydrogen peroxide stability upon contact with the resin was tested without preconditioning (Test 1) and with preconditioning (Test 2).

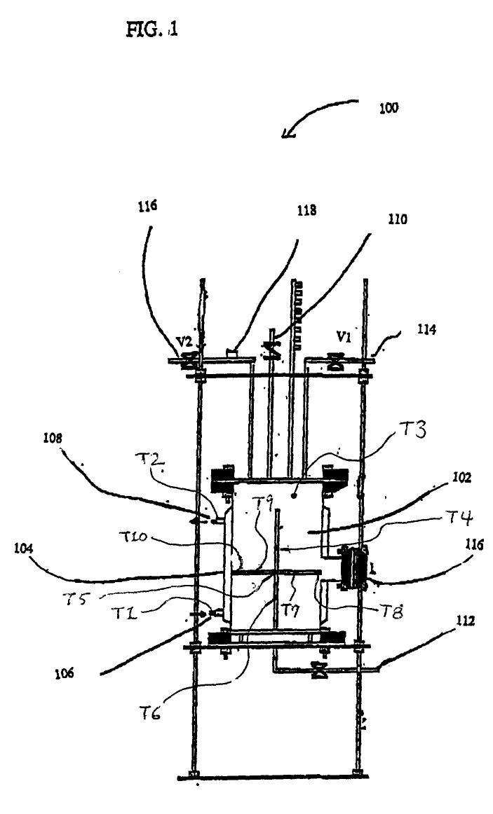

FIG. 1 is a longitudinal cross-sectional diagram of the apparatus used for measuring hydrogen peroxide decomposition in the two tests. The apparatus 100 includes reactor 102 and a cooling/heating jacket 104 which surrounds reactor 102 for controlling the temperature of the reactor.

The reactor is fitted with 10 thermocouples T1-T10. The thermocouples are distributed inside the reactor such that an accurate temperature profile can be obtained for various portions of the reactor. In particular, thermocouples T4-T10 are disposed in the reactor according to a cross-shaped arrangement centered at the center of the reactor. The thermocouple T3 is disposed in the top portion of the reactor such that the temperature above the resin charge is monitored. Thermocouples T1 and T2 allow the monitoring of the temperature at fluid entry 106 and fluid exit 108 of cooling/heating jacket 104. The reactor is also connected to a liquid feed line 110 and liquid evacuation line 112.

Gas feed lines 114 and gas evacuation line 116 are connected to the reactor such that gas is introduced into the reactor through line 114 and evacuated from the reactor through line 116. Lines 114 and 116 are fitted with electrically operated valves V1 and V2, respectively. The reactor is also fitted with a vent 116 which allows the reactor contents to leave the reactor when the pressure in the reactor reaches a predetermined value. The pressure is monitored through pressure sensor 118. The gas leaving the reactor through gas line 116 is analyzed to determine its contents.

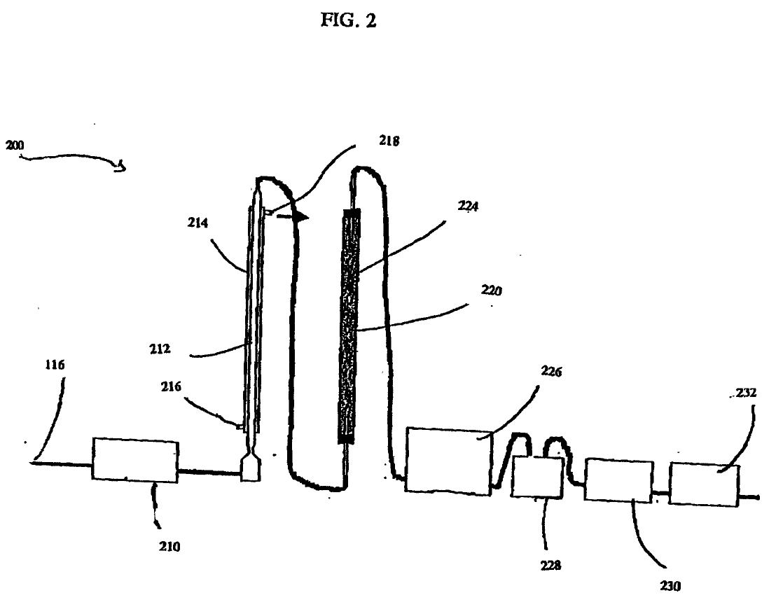

FIG. 2 is a schematic diagram of the analysis system 200 for analyzing the gas exiting the reactor 102. The gas from the reactor is fed through gas line into 116 oxygen detector 210. The gas is then fed into gas cooling column 212, which is surrounded by cooling fluid jacket 214. The cooling jacket has a fluid entry column 212 is connected to a gas drawing column 220, which is filled with a calcium chloride drawing charge 224. The drawing column is connected to a carbon monoxide/carbon dioxide infrared spectroscopy analyzer 226, which is connected to a gas meter 228 which is, in turn, connected to pressure build up sensor 230. The pressure build up sensor is connected to a carbon monoxide head 232.

Nitrogen was introduced into the reactor 102 through gas feed line 114 and evacuated from the reactor through gas evacuation line 116, such that a continuous flow of nitrogen was maintained above the resin bed in the reactor.

To determine the take off resin temperature for hydrogen peroxide decomposition, the reactor temperature was increased gradually while recording the temperature inside the reactor. At the start of the experiment, the reactor temperature was −10° C., which was then increased from −10° C. to 30° C. in steps of 5° C. For each step, the reactor temperature was maintained at a constant value until the temperature at the center of the reactor reached a temperature within 1° C. from the desired temperature (generally this required maintaining the temperature for about 15 minutes).

If the temperature at the center of the reactor was higher than the desired temperature, the temperature was maintained until the temperature at the center of the reactor became stabilized as indicated by a slope of less than 1° C. for 15 minutes. When a sharp increase in temperature was observed, the circulation of the fluid around the reactor was suspended and the reaction was allowed to proceed without temperature adjustment until the pressure inside the reactor reached a predetermined value, at which time the experiment was stopped. The temperature at which the sharp acceleration occurred was recorded as the take off temperature.

The flow of nitrogen above the resin bed was 0.4 liters per hour for temperatures between −10° C. and +10° C. and one liter per hour for temperatures between 10° C. and 30° C.

During the gradual increase of the reactor temperature, hydrogen peroxide samples was periodically extracted from the reactor and assayed for hydrogen peroxide concentration. The sampling was conducted when detectable hydrogen peroxide decomposition was indicated by either a temperature at the center of the reactor reaching the imposed temperature and/or the observation of oxygen gas emanations from the reactor.

### Test 1 (Comparative)

Two liters of dry AMBERSORB 563 were employed in testing the stability of hydrogen peroxide contacted with untreated AMBERSORB 563. The resin was hydrated by adding water to the resin and agitating slowly for at least five days. The resin was then drained and washed three times with ultra high purity water.

In a reactor containing a resin which was not preconditioned according to the invention and ultra high purity water, 3,539.9 grams of 30.68% of hydrogen peroxide of quality D at a temperature of −10° C. were passed through the resin. 2,670.2 grams of hydrogen peroxide were recovered. The hydrogen peroxide was assayed prior to and after passage through the resin bed. The hydrogen peroxide content in the recovered solution was 22.8%. Two more doses of fresh hydrogen peroxide were introduced into the reactor in batch mode also at a temperature of −10° C. The resin in the reactor was then covered to 1 cm above the resin bed with 30% hydrogen peroxide of grade D.

At the end of the test, hydrogen peroxide was drained from the reactor and assayed for hydrogen peroxide concentration. The resin was then rinsed with ultra high purity water in continuous mode. The resin was further rinsed with water in batch mode until the presence of hydrogen peroxide was no longer detected.

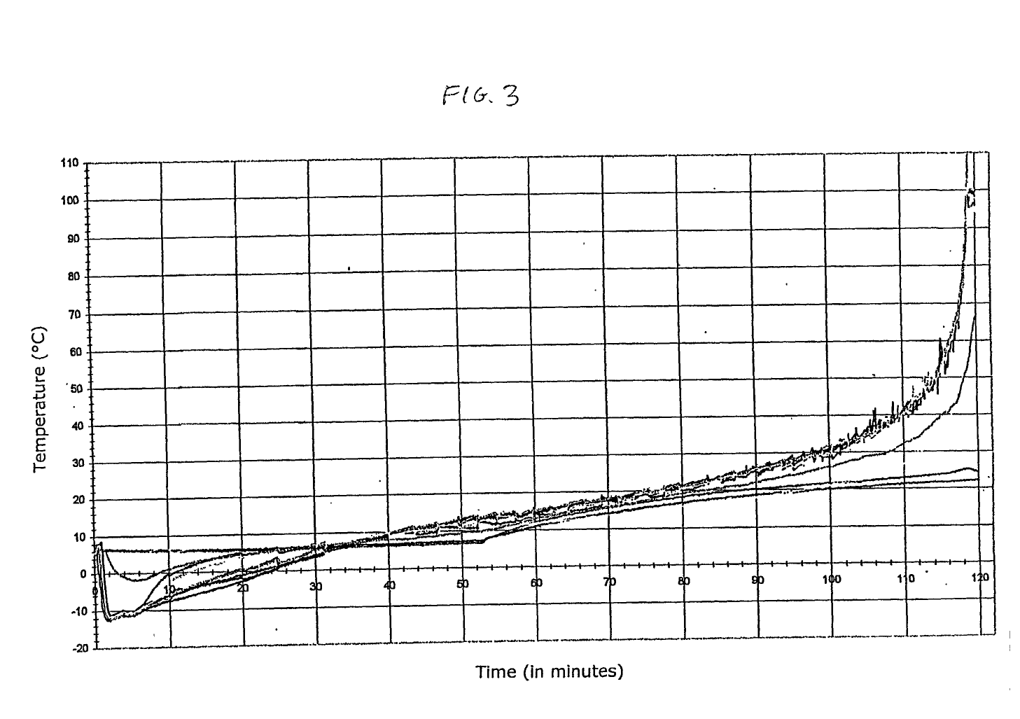

FIG. 3 shows the temperature profile obtained according to the above procedure for gradually increasing the reactor temperature. This Figure indicates that hydrogen peroxide decomposition took place starting at a reactor temperature of 6° C. with hydrogen peroxide introduced at a temperature of −10° C. After introduction of the hydrogen peroxide into the reactor, the temperature inside the reactor increased slowly until it reached 40° C., and then sharply increased signaling a sharp acceleration in hydrogen peroxide decomposition. Ultimately, a large amount of gas was produced, breaking the seal of a safety evacuation portal through which the contents of the reactor were ejected outside the reactor.

It should be noted that during the above test, the different temperature probes indicated that the increase in the temperature was uniformly distributed throughout the reactor and that the temperature inside the reactor reached 110° C. Analysis of the gas produced by hydrogen peroxide decomposition indicated a gas mixture containing 3.5% oxygen, 628 ppm carbon monoxide and more than 5,400 ppm carbon dioxide, with a gas flow rate of 54.2 liters per hour.

### Test 2 (Invention)

In order to assess the effect of the preconditioning in the resin according to the invention on hydrogen peroxide decomposition upon contact with the resin, the above test was duplicated using AMBERSORB 563 resin which was treated according to the invention.

1.11 liters of preconditioned AMBERSORB 563 were introduced into the reactor. The resin was then washed three times with water. The quantity of water adsorbed by the resin was determined by comparing the water introduced into the reactor and the water recovered from the reactor. The resin was further treated by introducing hydrogen peroxide into the reactor and removing the hydrogen peroxide from the reactor several times. Because removal of the hydrogen peroxide resulted in drying the resin, hydrogen peroxide was quickly reintroduced into the reactor to replace the removed hydrogen peroxide. In the final cycle, 485 grams of hydrogen peroxide were introduced into the reactor. The gradual increase of the reactor temperature was conducted according to the procedure discussed above with reference to Test 1. The temperature steps and the step durations during the test was as shown Table III below:

TABLE III

| Reactor | Temperature Duration |
|---|---|
| Temperature (° C.) | (hours:minutes) |
| −5 | 5:00 |
| 5 | 3:00 |
| 10 | 7:00 |
| 15 | 2.50 |
| 20 | 1.30 |
| 25 | 1.5 |
| 30 | 1.12 |
| 35 | 2:00 |
| 40 | 1:00 |
| 50 | 13:00 |

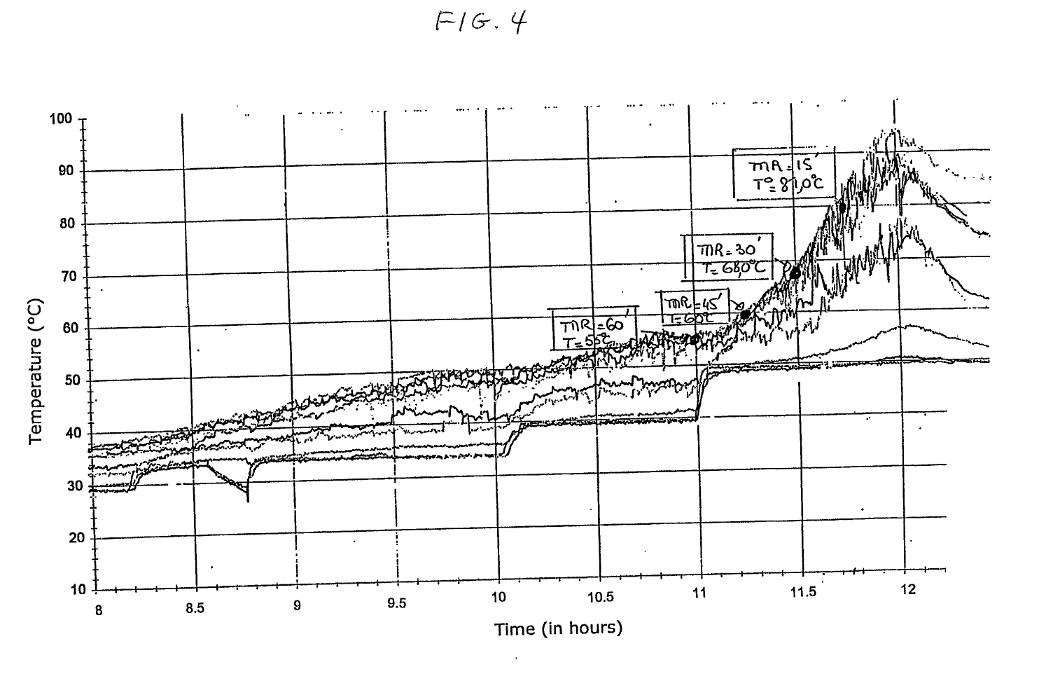

FIG. 4 shows the evolution of the temperature inside the reactor during the passage from a reactor temperature of 10° C. to 50° C. This Figure indicates that the reactor temperature increased according to the increase in the target temperature up to a reactor temperature of 5° C., at which the reactor temperature increased sharply and reached a maximum temperature of 90° C.

Comparing the results obtained with AMBERSORB 563 resin preconditioned according to the invention and without preconditioning shows that the preconditioning greatly stabilizes the resin such that hydrogen peroxide purification by AMBERSORB 563 can be conducted at temperatures up to 40° C. without acceleration of hydrogen peroxide decomposition upon contact with the resin.

### Example 5

In order to show the temperature stability associated with hydrogen peroxide TOC removal in a continuous flow mode using preconditioned resins according to the invention, a 30 cm high column was filled with 50 ml of AMBERSORB 563. The resin was preconditioned by treatment with diluted HCl according to the preconditioning process of the invention.

Hydrogen peroxide containing 16 ppm TOC was passed through the column at a flow rate of 15 ml/min and a temperature of 20° C. The flow was maintained for 978 minutes. The Temperature was measured, with the results shown in Table IV.

TABLE IV

| CONTACT TIME | TOTAL VOLUME | TEMPERATURE |
|---|---|---|
| (min.) | OF H₂O₂ (ml) | (° C.) |
| 0 | 0 | 20 |
| 6 | 32 | 20 |
| 22.5 | 167 | 20 |
| 43 | 432.5 | 20 |
| 92 | 1280 | 20 |
| 978 | 3811.5 | 20 |

As shown in Table IV, a remarkably stable temperature was obtained. The table shows that the temperature of the column remained constant at 20° C. for over 16 hours.

### Example 7

AMBERSORB 563 resin was placed in excess deionized water in a capped glass beaker for a soaking period of over seven days. At the end of the soaking period, the resin was separated from the deionized water and was rinsed three times with fresh deionized water.

The resin was next soaked in excess 5 wt % hydrochloric acid for 5 hours. The acid-treated resin was then rinsed and drained three times with fresh deiionized water, and stored in excess deionized water.

AMBERLITE XAD-4 was preconditioned by dilute HCl treatment according to the invention.

The preconditioned resins and the excess deionized water were placed in separate first and second glass columns (Spectra/Chrom) having a diameter of 2.5 cm and a height of 30 cm, and containing TEFLON fittings and tubing. The excess deionized water was removed from the columns. The bed volume for the AMBERSORB 563 and AMBERLITE XAD-4 was 100 cm³. The columns were set up in series such that a hydrogen peroxide solution could first be passed through the first column containing AMBERLITE XAD-4 in an upward flow mode, and then through the second column containing AMBERSORB 563 in an upward flow mode.

A 31 wt % ultrapure hydrogen peroxide solution containing 15 ppm TOC was passed through the first column with an upward flow of 40 ml/min and a starting temperature of 20° C. The hydrogen peroxide solution was then collected at the top of the first column and passed with an upward flow of 40 ml/min at a temperature of 20° C. through the second column in series with the first column. At the end of the purification process, the treated hydrogen peroxide was removed from the columns and replaced with deionized water.

Samples from the treated hydrogen peroxide solution were collected after passing the solution through the first column alone and after passing the solution through the first and second columns in series. The samples were placed in containers for assay and TOC analysis. The TOC analysis was conducted with a Shimadzu Model TOC-500A Automated Total Organic Carbon Analysis system. The hydrogen peroxide samples obtained from the treatment columns were diluted with ultra-high-purity water by a factor of two. Hydrogen peroxide assay tests were conducted using SEMI C1.9-96 potassium permamganate titration.

The results from the TOC and H₂O₂ assay anlysis are shown in Table V below.

TABLE V

| CONTACT | VOLUME | BED | TOC | TOC | | |
|---|---|---|---|---|---|---|
| TIME | OF H₂O₂ | VOLUME | XAD-4 | A563 | wt % H₂O₂, | wt % H₂O₂, |
| (min) | (ml) | H₂0₂ | (ppm) | (ppm) | XAD-4 | A563 |
| 0 | 0 | 0 | 15 | 15 | 31.3 | 31.3 |
| 30 | 1220 | 12.2 | 3.6 | <1 | 31.4 | 31.2 |
| 124 | 4980 | 49.8 | 4.3 | 1.7 | 31.2 | 31.2 |
| 248 | 9940 | 99.4 | 5.1 | 2.5 | 31.2 | 31.4 |
| 409 | 16,380 | 163.8 | 4.0 | 2.1 | 31.4 | 31.3 |
| 451 | 20,382 | 203.8 | 4.5 | 1.5 | 31.3 | 31.4 |
| 525 | 23,636 | 236.4 | 6.0 | 1.9 | 31.5 | 31.3 |
| 581 | 25,938 | 259.4 | 6.2 | 1.8 | 31.3 | 31.3 |
| 639 | 29,334 | 293.3 | 4.0 | 2.1 | 31.3 | 31.6 |

The data in Table V indicates that significant TOC removal can be attained when using one or two columns containing preconditioned resins according to the invention. The TOC removal results obtained after passing the solution through the first column (TOC XAD-4) show that AMBERLITE XAD-4 was effectve in the removal of a substantial part of the TOC impurities present in the starting solution. TOC content was decreased from 15 ppm to from 3.6 to 6.2 ppm by this first resin column.

The TOC content after the second column in series with the first column (TOC A563) reached values from as low as less than one ppm to 2.5 ppm. These results indicate that significant removal of TOC impurities can be obtained by passing the solution through a plurality of columns connected in series containing preconditioned resins according to the invention.

The results of Table V also show that hydrogen peroxide decomposition upon contact with the resin beds can effectively be prevented or minimized by use of the preconditioned resins in accordance with the invention. In this regard, the hydrogen peroxide assay results show that the hydrogen peroxide concentration in the solution after passing through the first column (wt% H₂O₂ XAD-4) and the second column (wt % H₂O₂ A563) remained essentially constant.

While the invention has been described in detail with reference to specific embodiments thereof, it will be apparent to those skilled in the art that various changes and modifications can be made, and equvalents employed, without departing from the scope of the claims which follow.

What is claimed is:

1. A method of preconditioning a resin useful for removal of organic impurities from a hydrogen peroxide solution, comprising the steps of:
(a) rinsing the resin with deionized water;
(b) contacting the resin with an acid solution; and
(c) rinsing the acid-treated resin with deionized water.

2. The method of claim 1, wherein the acid solution is selected from the group consisting of a hydrochloric acid solution, a nitric acid solution and a sulfuric acid solution.

3. The method of claim 2, wherein the acid solution is a hydrochloric acid solution.

4. The method of claim 3, wherein the molar ratio of hydrochloric acid to water in the hydrochloric acid solution is from about 1:100 to 1:90.

5. The method of claim 1, wherein step (b) is conducted for from about 3 to 8 hours.

6. The method of claim 1, wherein step (b) comprises soaking the resin in the acid solution in a batch mode.

7. The method of claim 6, wherein step (b) further comprises separating the resin and the acid solution and contacting the resin with a second acid solution, which is of the same type and concentration as the acid solution.

8. The method of claim 1, wherein the contacting in step (b) comprises introducing the resin and the acid solution into a vessel separating the resin and the acid solution and contacting the resin with a second acid solution.

9. The method of claim 1, wherein the resin is hydrophobic.

10. The method of claim 9, wherein the resin is AMBERLITE XAD-4 or AMBERSORE 563.

11. A resin preconditioned by the method of claim 1.

12. The resin of claim 11, wherein the resin is hydrophobic.

13. The resin of claim 11, wherein the resin is AMBERLITE XAD-4 or AMBERSORB 563.

14. The resin of claim 11, wherein the resin is effectve to maintain an essentially constant temperature when contacted with a hydrogen peroxide solution for at least eleven hours.

15. A method of removing organic impurities from a hydrogen peroxide solution, comprising passing the hydrogen peroxide solution through a column containing a resin bed, wherein the resin making up the resin bed has been preconditioned by a method comprising the steps of:
(a) rinsing the resin with deionized water;
(b) contacting the resin with an acid solution; and
(c) rinsing the acid treated resin with deionized water.

16. The method of claim 15, wherein the hydrogen peroxide solution has a hydrogen peroxide concentration of 50 wt % or less.

17. The method of claim 16, wherein the hydrogen peroxide solution has a hydrogen peroxide concentration of about 30 wt %.

18. The method of claim 15, wherein the resin is hydrophobic.

19. The method of claim 18, wherein the resin is AMBERLITE XAD-4 or AMBERSORB 563.

20. The method of claim 15, wherein the temperature of the hydrogen peroxide solution inside the column is essentially constant during the step of passing the hydrogen peroxide solution through the column.

21. The method of claim 15, wherein the hydrogen peroxide concentration in the hydrogen peroxide solution is maintained essentially constant during the step of contacting the resin with the hydrogen peroxide solution.

22. The method of claim 15, wherein the hydrogen peroxide solution is passed through the column in an upflow mode.

23. The method of claim 15, further comprising passing the hydrogen peroxide solution through a second column for removing organic impurities from the hydrogen peroxide solution, connected in series with and downstream from the first column.

24. The method of claim 15, further comprising passing the hydrogen peroxide solution through one or more columns containing an ion-exchange resin bed after passing the hydrogen peroxide solution through the column containing the preconditioned resin.
